(19) United States
(12) Patent Application Publication
(10) Pub. No.: US 2016/0018206 A1
(43) Pub. Date: Jan. 21, 2016

(54) STUD-SETTING CONSTRUCTION TOOL AND METHODS OF USE

(71) Applicant: StudBuddy Tools, LLC, Minden, LA (US)

(72) Inventors: Michael Scott HOLLIS, Bossier City, LA (US); Howard C. PRINCE, JR., Haughton, LA (US); Jeffery Brice REYNOLDS, Dubberly, LA (US)

(73) Assignee: STUDBUDDY TOOLS, LLC, Minden, LA (US)

(21) Appl. No.: 14/791,967

(22) Filed: Jul. 6, 2015

Related U.S. Application Data
(60) Provisional application No. 62/026,466, filed on Jul. 18, 2014.

(51) Int. Cl. G01B 3/30; E04B 2/70; G01C 9/34

(52) U.S. Cl. CPC G01B 3/30; G01C 9/34; E04B 2/70

(57) ABSTRACT

What is disclosed is generally directed to a simple, user-friendly, multipurpose, builder's stud-frame tool that is designed and engineered to help in laying-out and building typical 16-in. on-center, stud framing. The stud-frame tool is adapted to receive a stud on one end and a top plate or bottom frame plate on the other in order to facilitate easy placement, square-alignment, and fastening of a stud to a plate, resulting in no misaligned edges. In preferred embodiments, the stud-frame tool incorporates a two-dimensional bubble level or spirit level, has a light-weight, ergonomically designed handle, is substantially made of high-tensile-strength steel, and is powder-coated with thermoplastic or thermoset polymer to protect the tool surface and minimize chipping/scratching.

### CROSS-REFERENCE TO RELATED APPLICATIONS

This patent application claims the priority benefit of U.S. Patent Application No. 62/026,466 for “Stud-Setting Construction Tool and Methods of Use”, filed on Jul. 18, 2014, and U.S. Patent Application No. 62/026,466 is hereby incorporated by reference for all purposes.

### BACKGROUND

Stud-frame walls are a mainstay of most building construction. Those in the building-construction industry, carpenters, and the like often find themselves frustrated by the time-consuming process of trying to keep studs (e.g., 2×4 wood wall studs) in place, squared, and properly spaced from one another while fastening them. This is especially a problem while doing such work alone, which currently requires the use of multiple tools, including a framing square or speed square, a tape measure, and a level indicator. Carpenters often experience errors in measurements (requiring repeated re-measuring, leading to inefficiencies) and difficulties preventing studs from traveling while setting up adjacent studs, which in turn may require the unfastening and repositioning of studs to a frame plate. In addition, as studs tend to travel while a single worker struggles to properly position and fasten them to a plate, worker-safety issues are introduced. These problems translate into worker frustration, but more importantly translate into lost time and money during construction.

What is needed is an inexpensive, easy-to-use, framing-project tool to take guesswork out of stud placement, eliminate unwanted stud travel during fastening, improve worker safety, and save time for a builder.

### BRIEF SUMMARY

The present inventive disclosure is generally directed to a simple, user-friendly, multipurpose, builder's stud-frame tool that is designed and engineered to help in laying-out and building typical 16-in. on-center, stud framing. The stud-frame tool is adapted to receive a stud on one end and a top or bottom frame plate (plate) on the other in order to facilitate easy placement, square-alignment, and fastening of a stud to a plate, resulting in no misaligned edges.

In a preferred embodiment, the stud-frame tool is 16-in. in length with receiving cavities at each end: At a first end (the “head” of the stud-frame tool), a reinforced receiving cavity adapted to fit to the width of a 2×4 stud, and at the second end (the “butt” of the stud-frame tool), a receiving cavity adapted to fully receive a 2×4 plate that is orthogonally disposed relative to the aforementioned stud. Each receiving cavity is approximately 1½-in. deep, which corresponds to the thickness of a typical 2×4 stud. The 16-in. overall length is designed to facilitate the construction of a standard, 16-in. on-center, framing wall. In many variations, the stud-frame tool is made of high-tensile-strength steel that is powder-coated with thermoplastic or thermoset polymer to protect the tool surface and minimize chipping/scratching. The stud-frame tool is also equipped with an ergonomically designed, contoured, durable, and light-weight carbon-fiber-reinforced-polymer handle disposed on its top/upper surface and fastened to the body of the stud-frame tool with recessed stainless-steel fasteners. Added features in many embodiments include a built-in two-dimensional level (typically a bubble/spirit level), as well as ruler-lined scoring along the length of the stud-frame tool's straight edges and on many other straight edges associated with the stud/plate-receiving ends.

This embodiment of the stud-frame tool is specifically sized to help a user construct of a standard, 16-in. on-center, framing wall, though those skilled in the art would appreciate that the dimensions of the stud-frame tool can be adapted to virtually any alternative size/framing standard while providing the same functionality. In a typical use, a user will measure and place a first mark at 15¼ in. from the end of a top plate, then place the stud-frame tool flush on the top plate whereby the head of the tool aligns with the first mark. In this position, the first stud-receiving cavity in the tool head will be perfectly aligned for orthogonal placement of the end of a first stud against the top plate. A user then places the end of a stud into the first stud-receiving cavity to “lock” it into place, as the user can then insert a couple of fasteners (e.g., wood screws, nails, etc.) through the bottom of the top plate and into the perfectly aligned stud. A second stud can then be placed in a perfect position relative to the first stud by reversing the position of the stud-frame tool whereby the “butt” is placed immediately against the first-installed stud and the “head” is located along the top plate to receive the second stud using the same basic procedure to secure it as for the first stud. This process can be repeated for each subsequent stud as needed. The stud-frame tool can ensure that each subsequent stud is properly placed, even if there is a bow or twist in the stud.

Once all of the needed studs are attached to the top plate, the wall frame is vertically stood up and placed on the bottom plate in preparation for securing the array of studs to the bottom plate. Once again, the position of the stud-frame tool will be such that the head of the tool aligns at a mark placed 15¼ in. from the end of the bottom plate (this assumes that the top and bottom plates are of equal lengths). The first stud on the bottom plate will be positioned within the head of the stud-frame tool to ensure proper positioning prior to locking the position into the bottom plate with fasteners. The stud-frame tool's easy-grip handle helps a user keep the tool and stud safely in place as the user inserts fasteners into the stud via the open end of the tool head and into the bottom plate. Subsequent studs are each fixed to the bottom plate by fixing the stud's position with the stud-frame tool, which is placed abutted to the previously fixed stud. The multipurpose stud-frame tool can also be used to safely and efficiently insert horizontal 14½ in. “blocker” (aka “fire stop”) wood segments between adjacent studs, and can be similarly used to install windows, doors, headers, and packers during building projects.

Other uses of the multipurpose stud-frame tool include the ability to employ it as a three-dimensional framing square to make precise marking along a stud; as a speed square to ensure 90-degree cuts across boards (by positioning the butt of the tool against one edge of a board, and using the tool as a straight edge to draw the cross-cut line); and as a electrical-outlet box-positioning aid to easily ensure compliance with applicable building and electric codes.

The foregoing Brief Summary is intended to merely provide a short, general overview of the inventive disclosure described throughout this document, and therefore, is not intended to limit the scope of the inventive disclosure contained throughout the balance of this document, including the appended claims and drawings.

### BRIEF DESCRIPTION OF THE DRAWINGS

FIG. 1 depicts one embodiment of an isometric view of a multipurpose stud-frame tool, looking back-to-front.

FIG. 2 depicts one embodiment of an isometric view of a multipurpose stud-frame tool, looking front-to-back.

FIG. 3 depicts one embodiment of a top view of a multipurpose stud-frame tool.

FIG. 4 depicts one embodiment of a bottom view of a multipurpose stud-frame tool.

FIG. 5 depicts one embodiment of an elevated side view of a multipurpose stud-frame tool.

FIG. 6 depicts one embodiment of a side view of a multipurpose stud-frame tool.

FIG. 7 depicts one embodiment of a front view of a multipurpose stud-frame tool.

FIG. 8 depicts one embodiment of a rear view of a multipurpose stud-frame tool.

FIG. 9 depicts one embodiment of the application of a multipurpose stud-frame tool, setting the orientation between a plate and a stud.

FIG. 10 depicts one embodiment of the application of a multipurpose stud-frame tool, setting the orientation between a plate and a stud of FIG. 9, wherein a user is fastening the oriented stud to its top plate.

FIG. 11 depicts one embodiment of the application of a multipurpose stud-frame tool, setting the orientation between a plate and a stud, showing the spacing between two studs using the tool.

FIG. 12 depicts one embodiment of the application of a multipurpose stud-frame tool, setting the orientation between a bottom plate and a stud of FIG. 9, wherein a user is fastening the oriented stud to its plate from the side while the frame wall is set up vertically onto the bottom plate.

FIG. 13 depicts one embodiment of a closer view of the application of a multipurpose stud-frame tool, setting the orientation between a plate and a stud of FIG. 9, wherein a user is fastening the oriented stud to its plate from the side while the frame wall is set up vertically.

FIG. 14 depicts one embodiment of the use of a multipurpose stud-frame tool to install a “blocker” (or “fire stop”) between studs in a wall frame.

FIG. 15 depicts a close-up view one embodiment of the use of a multipurpose stud-frame tool during the installation of a “blocker” (or “fire stop”) between studs in a wall frame, as shown in FIG. 14, said view focusing on the use of the two-dimensional level incorporated in the tool.

FIG. 16 depicts one embodiment of a multipurpose stud-frame tool being used as a three-dimensional framing square to make precise marking along a stud.

FIG. 17 depicts one embodiment of a multipurpose stud-frame tool being used as a three-dimensional framing square to help a user properly position an electrical-outlet box according to applicable building codes.

FIG. 18 depicts one embodiment of a multipurpose stud-frame tool being used as a three-dimensional framing square to allow a user to mark precise orthogonal cross-cut lines across a wooden board to be cut.

### DESCRIPTION

### I. Terminology

The terms and phrases as indicated in quotes (“ ”) in this Section are intended to have the meaning ascribed to them in this Terminology Section applied to them throughout this document, including the claims, unless clearly indicated otherwise in context. Further, as applicable, the stated definitions are to apply, regardless of the word or phrase's case, to the singular and plural variations of the defined word or phrase.

The term “or”, as used in this specification and the appended claims, is not meant to be exclusive; rather, the term is inclusive, meaning “either or both”.

References in the specification to “one embodiment”, “an embodiment”, “a preferred embodiment”, “an alternative embodiment”, “a variation”, “one variation”, and similar phrases mean that a particular feature, structure, or characteristic described in connection with the embodiment is included in at least an embodiment of the invention. The appearances of the phrase “in one embodiment” and/or “in one variation” and similar phrases in various places in the specification are not necessarily all meant to refer to the same embodiment.

The term “couple” or “coupled”, as used in this specification and the appended claims, refers to either an indirect or a direct connection between the identified elements, components, or objects. Often the manner of the coupling will be related specifically to the manner in which the two coupled elements interact.

The term “removable”, “removably coupled”, “readily removable”, “readily detachable”, “detachably coupled”, and similar terms, as used in this specification (including the claims and drawings), refer to structures that can be uncoupled from an adjoining structure with relative ease (i.e., non-destructively and without a complicated or time-consuming process) and that can also be readily reattached or coupled to the previously adjoining structure.

Directional and/or relational terms such as, but not limited to, left, right, nadir, apex, top, bottom, vertical, horizontal, back, front, lateral, proximal, and distal are relative to each other, are dependent on the specific orientation of an applicable element or article, are used accordingly to aid in the description of the various embodiments, and are not necessarily intended to be construed as limiting in this specification and the appended claims.

As applicable, the terms “about” or “generally”, as used herein unless otherwise indicated, means a margin of +−20%. Also, as applicable, the term “substantially” as used herein unless otherwise indicated means a margin of +−10%. It is to be appreciated that not all uses of the above terms are quantifiable such that the referenced ranges can be applied.

The terms “2×4”, “2×4 stud”, “2×4 plate”, and similar terms, as used in this specification (including the claims and drawings), refer to a common size of dimensional lumber (i.e., the cross-section of a board is a “two by four”) that is named for its unprocessed cross-sectional dimensions, and actually usually measures 1½×3½ inches in practice. In addition, while 2×4 studs and plates are referenced throughout this patent application because this cross-sectional sizing is the most common application, it should be appreciated by those skilled in the art that the stud-frame tool embodiments described herein can be sized to accommodate other standard board sizes (e.g., 2×6 boards) and on-center frame specifications.

### II. A Multipurpose, Builder's Stud-Frame Tool

This Section II is generally directed to embodiments of a simple, user-friendly, multipurpose, builder's stud-frame tool that is designed and engineered to help in laying-out and building typical 16-in. on-center, stud framing. However, the stud-frame tool described herein can be sized to accommodate other on-center, stud-framing standards and various board sizes (though 2×4 studs are the most commonly used in the industry, so they are used as examples throughout this disclosure). The stud-frame tool is adapted to receive a stud on one end and a top or bottom frame plate (plate) on the other in order to facilitate easy placement, alignment, and fastening of a stud to a plate.

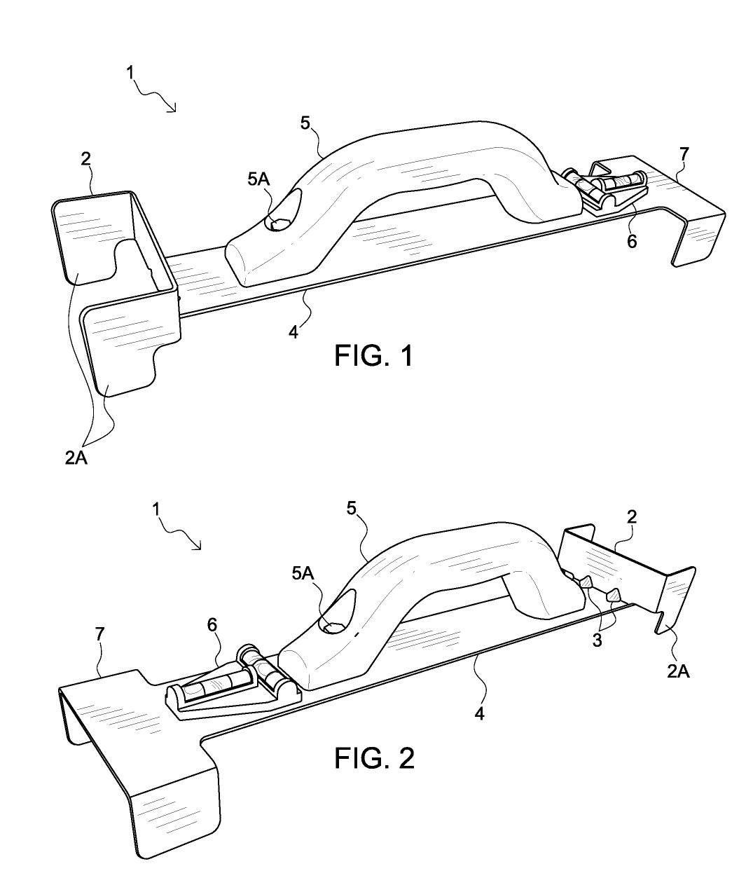

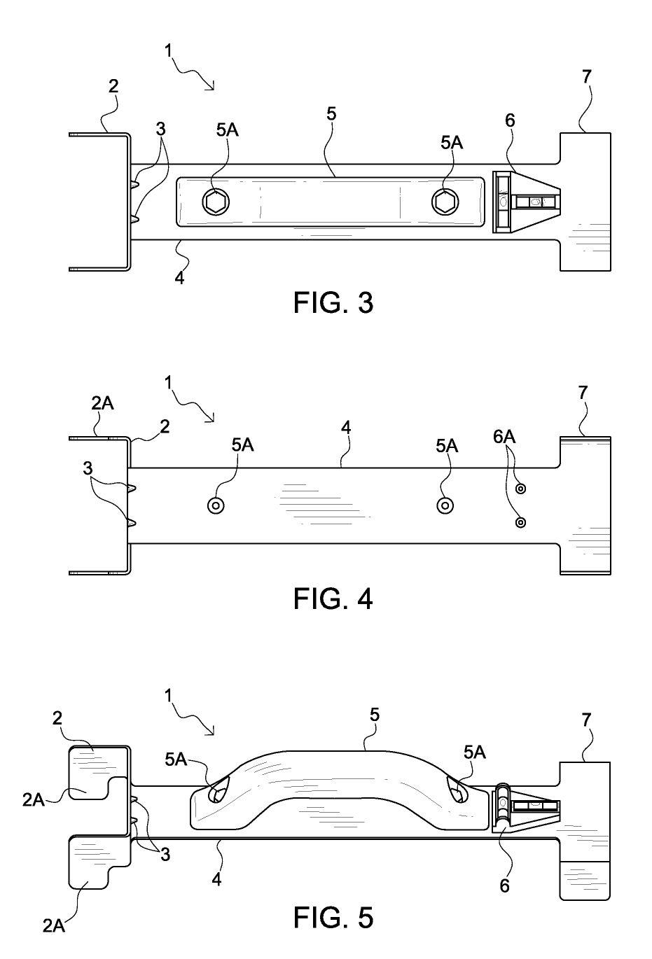

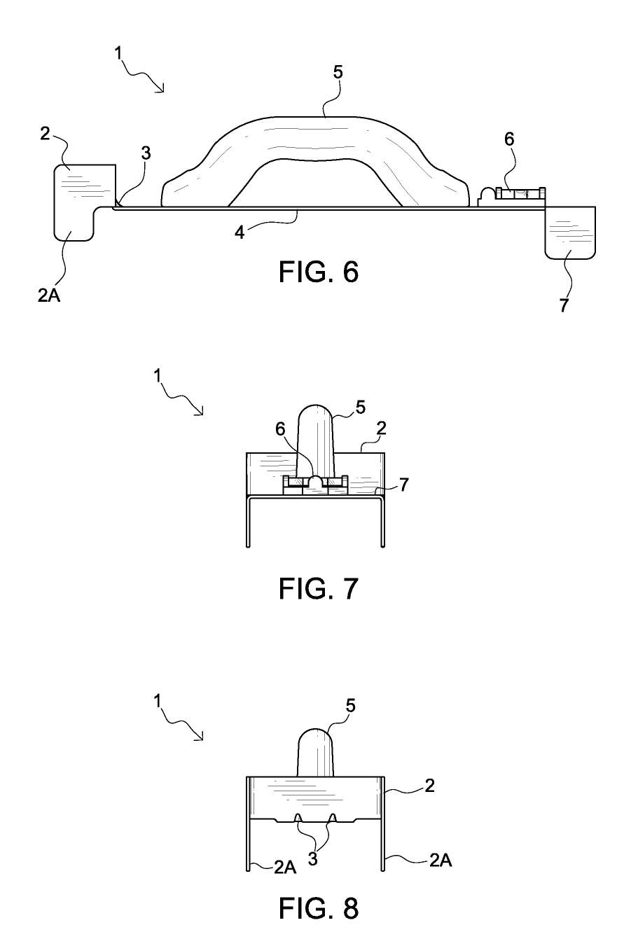

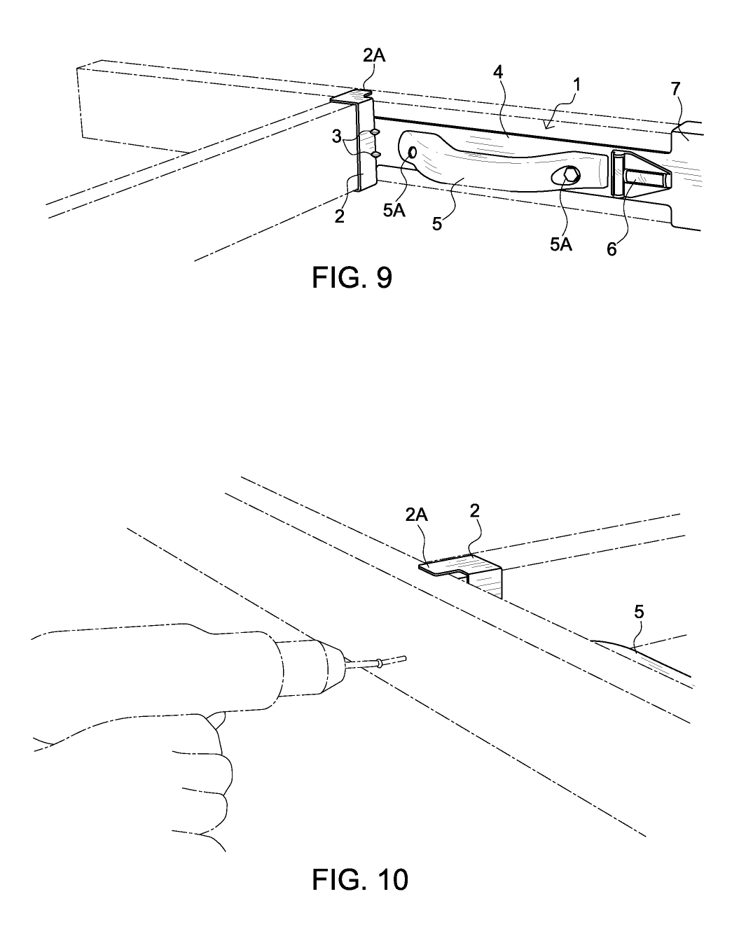

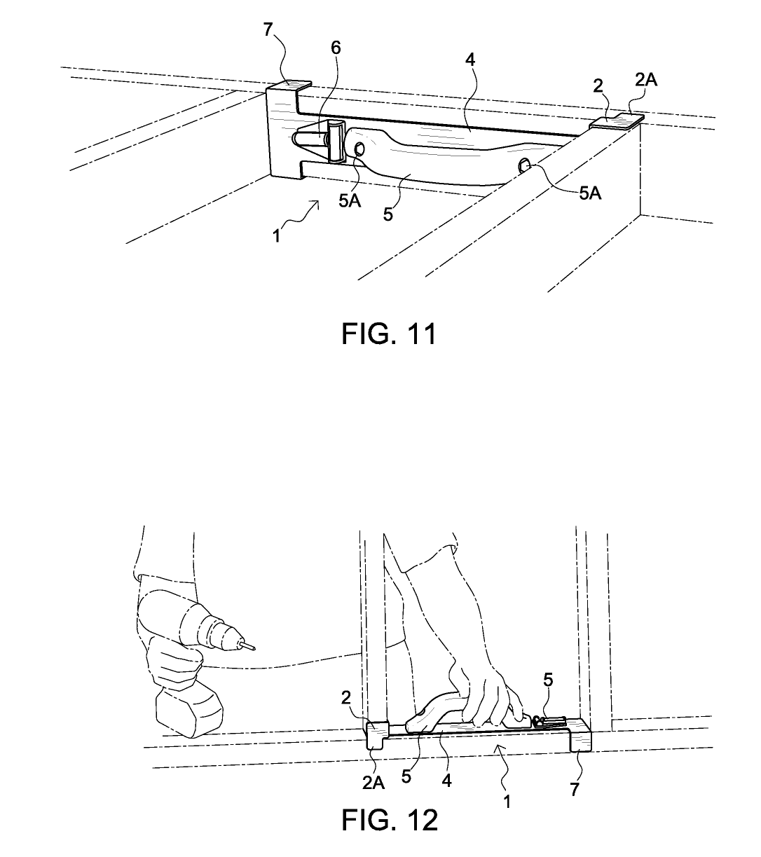

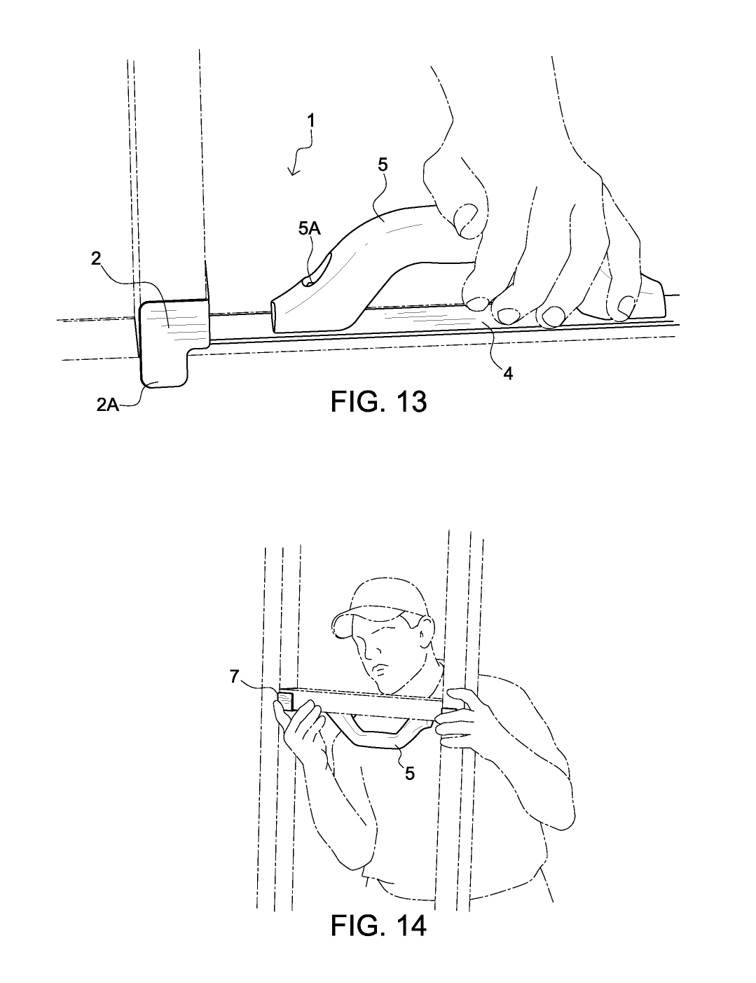

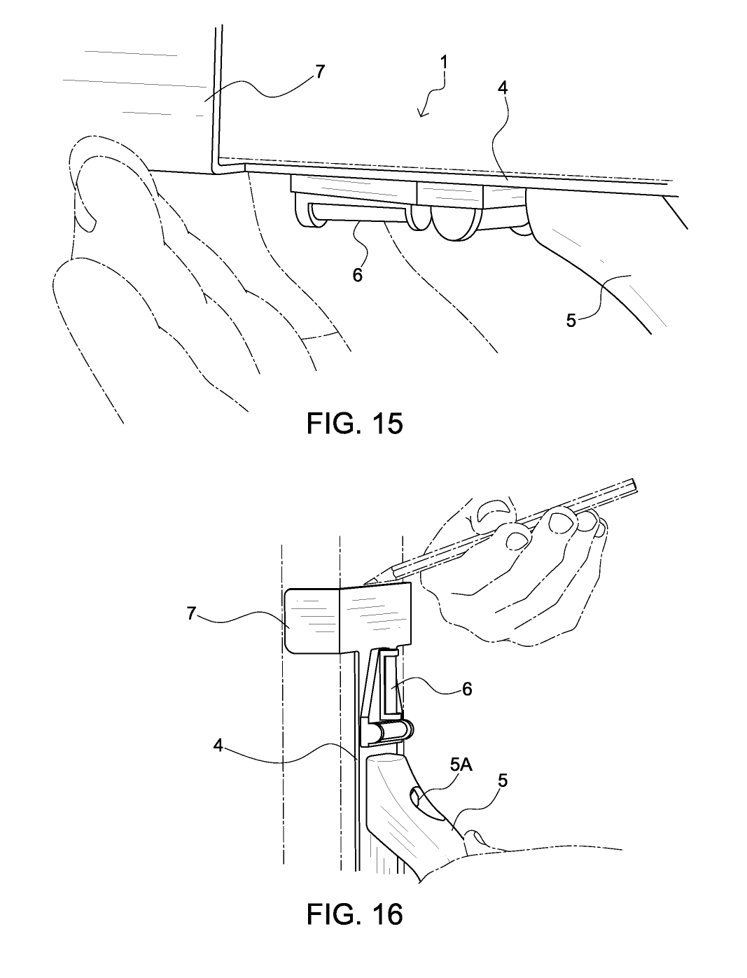

Refer to FIGS. 1-8. In an embodiment, the stud-frame tool 1 is 16-in. in length with receiving cavities 2, 7 at each end: At a first end 7 (the “head” of the stud-frame tool 1), a reinforced receiving cavity 7 is adapted to fit to the width of a 2×4 stud, and at the second end 2 (the “butt” of the stud-frame tool 1) is a receiving cavity 2 adapted to fully receive a 2×4 plate that is orthogonally disposed relative to the aforementioned stud. In many variations, the butt 2 has extended rounded-corner tabs 2A on each side to both create a larger receiving cavity and to create a landing foot of sorts when the stud-frame tool 1 set down on a flat surface. Each receiving cavity 2, 7 is approximately 1½-in. deep, which corresponds to the thickness of a typical 2×4 stud. In still other variations, the respective receiving cavities of head 7 and butt 2 are adapted to receive other standard industry board cross-sectional sizes, such as 2×6 (1½-in ×5½-in cross-section) boards.

The stud-receiving cavity 2, having an orthogonal bend relative to the main body 4 of the tool 1, is typically provided with structural reinforcement by either one or more gussets 3 welded within the interior of the orthogonal bend. In a preferred embodiment, this structural reinforcement is instead in the form of one or more bead rolls 3 that serve the same purpose of a gusset, but allow for less material to be used and make fabrication easier and less-expensive. In still additional variations, one or more weld beads are disposed within the interior of the orthogonal bend.

The 16-in. overall length and sizes of the receiving cavities 2, 7 are designed to facilitate the construction of a standard, 16-in., on-center framing wall; that is, a 14½-inch spacing between studs. Of course, those of ordinary skill in the art would appreciate that the stud-frame tool could be fabricated in a size to conform to another standard for building a frame wall, as the main idea behind the tool 1 is that its predetermined lengths and board-receiving cavity sizes can make it much easier and quicker for carpenters and the like to properly space and fix into place studs on wall-frame plates with confidence in the accuracy of the spacing measurements.

In many preferred variations, the stud-frame tool 1 is made of high-tensile-strength steel that is powder-coated with thermoplastic or thermoset polymer to protect the tool surface and minimize chipping/scratching. In some cases, other sturdy materials may be used in place of steel, such as various other metal alloys or hard plastic or composite materials. In addition, other coating materials known in the art may be used.

In many variations, the stud-frame tool 1 is also equipped with an ergonomically designed, contoured, durable, and light-weight carbon-fiber-reinforced-polymer handle 5 disposed on and fastened to the upper surface of the body 4 of the stud-frame tool with recessed stainless-steel fasteners 5A that extend from the bottom surface 4 of the tool 1, through the body 4, and engaging the handle 5. Of course, many alternative materials can be used for the handle member 5, including wood, steel, or other types of polymers. In some preferred embodiments, at least two recessed stainless-steel bolts 5A are inserted into the handle member 5 and the bolts 5A threadably engage stainless-steel nuts 5A that as disposed in recesses in the bottom of the body 4 of the stud-frame tool 1. Of course, in many other embodiments, a number of other threaded fasteners 5A can be used to secure the handle member 5 to the body member 4.

Added features in other embodiments include a built-in two-dimensional level 6 (typically a bubble/spirit level, but other types of levels can be incorporated), as well as ruler-lined scoring (not shown) along the length of the stud-frame tool's 1 straight edges 4 and on many other straight edges associated with the stud/plate-receiving ends 2, 7.

### III. A Multifunctional Construction Stud-Framing-Aid Tool

This Section III is generally directed to various embodiments of a hand-held, multifunctional stud-framing-aid tool that is adapted to aid in on-center stud framing. Refer to FIGS. 1-8.

In an embodiment, the stud-frame tool 1 comprises: An elongate, substantially planar, body member 4, said body member 4 has a first end and a second end, and has an upper surface and bottom surface; wherein the elongate body member 4 is of a predetermined length (in many variations, the predetermined length predetermined length corresponds to a construction-industry standard for the spacing between studs in a stud-frame wall); A head member 7 disposed at the body member's 4 first end, wherein the head member 7 is a receiving cavity adapted to slidably fit the width of a predetermined standard lumber board (in many variations, adapted to receive the width of a standard 2×4 board, which corresponds to a 3½-inch width), and wherein the head member 7 receiving cavity is disposed longitudinally inline relative to said elongated body member 4, and a butt member 2 disposed at the body member's 4 second end, wherein the butt member 2 is a receiving cavity adapted to slidably fit the width of a predetermined standard lumber board (in many variations, adapted to receive the width of a standard 2×4 board, which corresponds to a 3½-inch width), and wherein the butt member 2 receiving cavity is orthogonally disposed relative to the elongated body member 4. In still other variations, the respective receiving cavities of head member 7 and butt member 2 are adapted to receive other standard board sizes; for example, 2×6 (1½-in ×5½-in cross-section) boards.

In many variations, the butt member 2 has extended rounded-corner tabs 2A on each side to both create a larger receiving cavity and to create a landing foot of sorts when the stud-frame tool 1 set down on a flat surface.

In variations of the stud-frame tool 1, the predetermined body member 4 length combined with the head member 7 length is approximately 14½ inches in order to support standard 16-inch, on-center stud framing. That is, given that a typical 2×4 board is 1½ inches thick, ensuring that there is a 14½-inch spacing between adjacent studs with the stud-frame tool 1 from the center of one stud measured across the narrow cross-section, ensures that the center of adjacent stud ends are spaced 16 inches apart. Of course, a person of ordinary skill in the art would immediately appreciate that the general design of the stud-frame tool 1 can be scaled up or down to accommodate other standards.

In many preferred embodiments, the stud-frame tool 1 further comprises a level device 6 configured to provide a user with indications of the levelness of the stud-frame tool along at least two axes. In variations, the built-in level 6 type used is selected from the group consisting of bubble, spirit, circular, bull's eye, surface, torpedo, laser, and electronic. In some embodiments, the level device 6 is attached to the body member 4 using recessed, stainless-steel fasteners 6A. However, in other variations, the built-in level 6 is attached to the body member 4 using adhesives.

In still more embodiments, the stud-frame tool 1 is equipped with a handle member 5 fixedly disposed on the upper surface on the body member 4. In typical variations, the handle member 5 is contoured to be easy-to-grip and comfortable for a user, and is substantially made from a sturdy, light-weight material such as carbon-fiber-reinforced polymer, wood, and aluminum alloy, though other materials can be used. In many variations, the handle member 5 is attached to the body member 4 by way of a plurality of recessed, preferably threaded, fasteners 5A extending from the bottom surface of the body member 4, through the body member 4, and into the handle member 5. In a preferred example, a pair of stainless-steel bolts 5A are inserted into recessed holes in the handle member 5, which extend trough the body member 4, and threadably engage a pair of stainless-steel nuts 5A that are recessed into the bottom surface of the body member 4. In other variations, the handle member 5 can be adapted to be readily detachably coupled to the body member 4 by way of quick-release fastener schemes (e.g., tab-and-slot interference fit, strong hook-and-loop, and other methods well-known in the art.

In some embodiments, the body member 4, head member 7, and butt member 2 are formed from a single piece of sheet metal (in preferred embodiments, high-tensile-strength steel), that is cut and bent accordingly. In less-preferred embodiments, the body member 4, head member 7, and butt member 2 are formed separately and then welded together. In such a case, structural reinforcement of the orthogonal weld joint/bend between the body member 4 and the butt member 2 is preferred and in some variations is by way of one or more gussets 3 welded within the interior of the orthogonal weld joint/bend. In preferred embodiments, in which the stud-frame tool's 1 body member 4, head member 7, and butt member 2 are all formed from a single piece of sheet metal, the structurally reinforcement at the orthogonal bend can be provided via one of more bead rolls 3 disposed within the interior of the orthogonal joint or bend between said body member and said butt member 2. Similarly, in still more variations, one or more weld beads can be disposed within the interior of the orthogonal bend to provide the added support and stability of the joint/bend between the butt member 2 and the body member 4. In some variations, the stud-frame tool 1 body member 4, head member 7, and butt member 2 are formed as a unit out of hard plastic, similar structures to a gussets 3 or bead rolls 3 can be incorporated into the form.

In many embodiments, the stud-frame tool's main structure (that is, the body member 4, the head member 7, and the butt member 2) is given a protective coating for both aesthetic reasons and to protect the stud-frame tool 1 itself. In preferred embodiments, the protective coating is a powder coating with a material selected from thermoplastic and/or thermoset polymer.

In other embodiments, the stud-frame tool 1, which has many straight edges inherent in its body member 4, head member 7, and butt member 2, is provided with ruler-type markings (not shown) along one or more straight edges of the stud-frame tool 1. In particular, the longitudinal edges of the body member 4 are particularly suitable and useful for including such markings. In some variations, the markings are provided by scoring or stamping into the metal of stud-frame tool 1 along the desired edges. In still more variations, the ruler markings are provided by printing on the stud-frame tool 1 or affixing preprinted laminates to the desired edges of the stud-frame tool 1. In some embodiments, the ruler markings are in metric units and/or United States English units of length measurement. In some cases, the preprinted laminate ruler markings can be removably attached to the stud-frame tool 1 with relatively low-strength adhesive, so a stud-frame tool 1 could be reconfigured with ruler markings that suit a user's particular needs on a given job.

### IV. Methods of Using a Multipurpose, Builder's Stud-Frame Tool to Construct a Framing Wall

This Section IV is generally directed to methods-of-use for embodiments of the stud-frame tool 1, as described in Sections II and III, wherein the tool is specifically sized to help a user construct of a standard, 16-in. on-center framing wall, though in some embodiments, other on-center framing dimensions and standards can be supported. Refer to FIGS. 1-8; 9-15. In a typical use, a user will measure and place a first mark at 15¼ in. from the end of a top plate (to ensure that the center of the first stud, having a 1½-in. thickness, is located at the 16-in. point on the plate. Then, the stud-frame tool 1 is placed flush on the top plate whereby the head 7 of the stud-frame tool 1 aligns with the first mark. In this position, the stud-receiving cavity in the tool butt 2 will be perfectly aligned for orthogonal placement of the end of a first stud against the top plate. A user then places the end of a stud into the butt's 2 stud-receiving cavity to “lock” it into place, as the user can then insert some fasteners (e.g., wood screws, nails, etc.) through the bottom of the top plate and into the perfectly aligned stud. A second stud can then be placed in a perfect position relative to the first stud by reversing the position of the stud-frame tool 1 whereby the head 7 is placed immediately against the first-installed stud and the butt 7 is located along the top plate to receive the second stud using the same basic procedure to secure it as for the first stud.

This process can be repeated for each subsequent stud as needed. The stud-frame tool 1 can ensure that each subsequent stud is properly placed, even if there is a bow or twist in the stud. Once all of the needed studs are attached to the top plate, the wall frame is vertically stood up and placed on the bottom plate in preparation for securing the array of studs to the bottom plate. Once again, the position of the stud-frame tool 1 will be such that the head 7 of the tool aligns at a mark placed 15¼ in. from the end of the bottom plate (this assumes that the top and bottom plates are of equal lengths). The first stud on the bottom plate will be positioned within the butt 7 of the stud-frame tool 1 to ensure proper positioning prior to locking the position into the bottom plate with fasteners. The stud-frame tool's 1 easy-grip handle 5 helps a user keep the tool and stud safely in place as the user inserts fasteners into the stud via the open end of the tool butt 2 and into the bottom plate. Subsequent studs are each fixed to the bottom plate by fixing the stud's position with the stud-frame tool 1, which is placed with its head 7 against the previously fixed stud.

Once the all of the studs are attached to the top and bottom plates, the stud-frame tool 1 can also be used to safely and efficiently insert horizontal 14½ in. “blocker” (aka “fire stop”) wood segments between adjacent studs. To accomplish this, a “blocker” is placed longitudinally flush with the stud-frame tool 1 such that the end of the “blocker” is disposed within the head cavity 7 of the stud-frame tool 1 and the end of the “blocker” is flush with the head 7 of the stud-frame tool 1. Then, with the exposed “blocker” surface facing upward and the tool handle 5 facing downward, the tool's 1 butt 2 cavity is used to engage with a stud at a user-selected height, whereby the length of the entire tool-and-blocker is exactly the width between the adjacent studs. The level indicators 6 on the stud-frame tool 1 can be used to ensure that the “blocker” is perfectly level before securing the “blocker” on each end to the respective studs with appropriate fasteners.

The stud-frame tool can be similarly used to install windows, doors, headers, and packers during building projects.

### V. Miscellaneous Methods of Using a Multipurpose, Builder's Stud-Frame Tool

This Section V is generally directed to various additional uses of the stud-frame tool described in Sections II and III. Refer to FIGS. 1-8; 15-17.

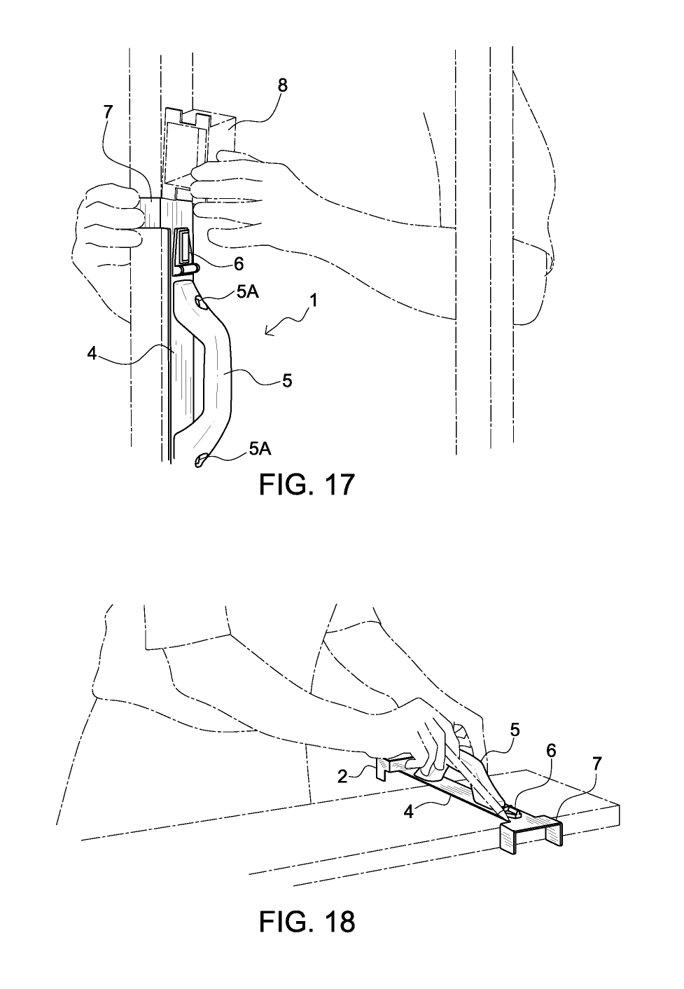

One such use is as a three-dimensional framing square to make precise marking along a stud, as shown in FIG. 16. Further, as depicted in FIG. 17, the stud-frame tool 1 can be positioned along a stud, relative to the bottom plate (or top plate in rare cases) such that an electrical outlet box 8 can be positioned at the end of the tool adjacent to the stud, then easily and securely positioned with proper placement (that is, 16 in. from the bottom plate, pursuant to most U.S. electrical codes). Further, as shown in FIG. 18, the stud-frame tool 1 can be used as a speed square to ensure 90-degree cuts across boards (by positioning the head 7 of the stud-frame tool 1 against one edge of a board, and using the stud-frame tool's 1 body member 4 as a straight edge to draw the cross-cut line).

### VI. Alternative Embodiments and Other Variations

The various embodiments and variations thereof described herein, including the appended Claims and/or illustrated in the accompanying Figures are merely exemplary and are not meant to limit the scope of the inventive disclosure. It should be appreciated that numerous variations of the invention have been contemplated as would be obvious to one of ordinary skill in the art with the benefit of this disclosure. Hence, those ordinarily skilled in the art will have no difficulty devising myriad obvious variations and improvements to the invention, all of which are intended to be encompassed within the scope of the Description, Claims, and Figures herein.

What is claimed is:

1. A multifunctional construction tool to aid in on-center stud framing, comprising:
an elongate, substantially planar, body member, said body member having a first end and a second end, and an upper surface and bottom surface, wherein:
said elongate body member is of a predetermined length;
a butt member disposed at said body member's first end, wherein:
said butt member is a receiving cavity adapted to slidably fit the width of a predetermined standard lumber board, and
said butt member receiving cavity is orthogonally disposed relative to said elongated body member; and
a head member disposed at said body member's second end, wherein:
said head member is a receiving cavity adapted to slidably fit the width of a predetermined standard lumber board,
said head member's receiving cavity is disposed longitudinally inline relative to said elongated body member,
said head member's length, measured longitudinally inline with said body member, is of a predetermined length, and
said predetermined length, when combined with said body member's predetermined length, corresponds to a construction-industry standard for the spacing between studs in a stud-frame wall.

2. The tool of claim 1, wherein said predetermined body member length is approximately 13 inches and said predetermined length of said head member is approximately 1½ inches in order to support standard 16-inch, on-center stud framing.

3. The tool of claim 1, wherein said predetermined standard lumber board width for each of said head member and butt member corresponds to the width of a standard industry board cross-sectional size, said standard industry board cross-sectional size selected from the group consisting of 2×4 boards and 2×6 boards.

4. The tool of claim 1, further comprising a built-in level, adapted to measure at least along two axes, coupled to the upper surface of said body member.

5. The tool of claim 4, wherein said built-in level is of a type selected from the group consisting of bubble, spirit, circular, bull's eye, surface, torpedo, laser, and electronic.

6. The tool of claim 1, further comprising a handle member fixedly disposed on the upper surface on said body member.

7. The tool of claim 6, wherein said handle member is attached to said body member using a plurality of recessed threaded fasteners.

8. The tool of claim 6, wherein said handle member is detachably coupled to said body member using a plurality of quick-release fasteners.

9. The tool of claim 6, wherein said handle member is contoured and substantially comprised of a durable and light-weight material selected from the group consisting of carbon-fiber-reinforced polymer, wood, and aluminum alloy.

10. The tool of claim 1, wherein said body member, butt member, and head member are formed from a piece of sheet metal.

11. The tool of claim 10, wherein said sheet metal is substantially made of high-tensile-strength steel.

12. The tool of claim 10, wherein said butt member's orthogonal coupling to said body member is reinforced by one or more gussets welded within the interior of the orthogonal joint or bend between said body member and said butt member.

13. The tool of claim 10, wherein said butt member's orthogonal coupling to said body member is reinforced by one or more bead rolls disposed within the interior of the orthogonal joint or bend between said body member and said butt member.

14. The tool of claim 1, wherein said body member, butt member, and head member are substantially powder-coated with a material selected from the group consisting of thermoplastic and thermoset polymer.

15. The tool of claim 1, further comprising at least one set of incremented ruler markings along at least one longitudinal edges of said body member.

16. The tool of claim 15, wherein said at least one set of incremented ruler markings are disposed on said body member by a means selected from the group consisting of scoring, printing, and affixing preprinted laminate material.

17. The tool of claim 16, wherein if said at least one set of incremented ruler markings are disposed on said body member by using preprinted laminate material, said laminate preprinted material is removably coupled to the surface of said body member and interchangeable with different preprinted laminate materials.

18. The tool of claim 15, wherein said at least one set of incremented ruler markings are in at least one of metric units or United States English units.

19. The tool of claim 1, wherein:
said predetermined body member length combined with said pretermined head member length is approximately 14½ inches in order to support standard 16-inch, on-center stud framing;
said predetermined standard lumber board width for each of said head member and butt member corresponds to the width of a standard industry board cross-sectional size, said standard industry board cross-sectional size selected from the group consisting of 2×4 boards and 2×6 boards;
said body member, butt member, and head member are formed from a piece of sheet metal substantially comprised of high-tensile-strength steel;
said butt member's orthogonal coupling to said body member is reinforced by one or more bead rolls disposed within the interior of the orthogonal joint or bend between said body member and said butt member; and
said body member, butt member, and head member are substantially powder-coated with a material selected from the group consisting of thermoplastic and thermoset polymer.

20. The tool of claim 19, further comprising:
a built-in level, adapted to measure at least along two axes, coupled to the upper surface of said body member, wherein said built-in level is of a type selected from the group consisting of bubble, spirit, circular, bull's eye, surface, torpedo, laser, and electronic;
a handle member fixedly disposed on the upper surface on said body member, wherein:
said handle member is attached to said body member using a plurality of recessed threaded fasteners, and
said handle member is contoured and substantially comprised of a durable and light-weight material selected from the group consisting of carbon-fiber-reinforced polymer, wood, and aluminum alloy;
at least one set of incremented ruler markings along at least one longitudinal edges of said body member, wherein:
said at least one set of incremented ruler markings are disposed on said body member by a means selected from the group consisting of scoring, printing, and affixing preprinted laminate material, and
said at least one set of incremented ruler markings are in at least one of metric units or United States English units.
